(19) United States
(12) Patent Application Publication
(10) Pub. No.: US 2014/0194125 A1
(43) Pub. Date: Jul. 10, 2014

(54) METHODS IMPLEMENTING A CONFIGURATION OF DRX AND MEASUREMENT IN A UE AND AN ENODEB EQUIPMENT

(71) Applicants: Pingping Wen, Shanghai (CN); Chongxian Zhong, Shanghai (CN); Jialin Zou, Randolph, NJ (US); Tao Yang, Shanghai (CN)

(72) Inventors: Pingping Wen, Shanghai (CN); Chongxian Zhong, Shanghai (CN); Jialin Zou, Randolph, NJ (US); Tao Yang, Shanghai (CN)

(73) Assignee: Alcatel Lucent, Paris (FR)

(21) Appl. No.: 14/234,571

(22) PCT Filed: Jul. 13, 2012
(86) PCT No.: PCT/IB2012/001451

§ 371 Date: Jan. 23, 2014

(30) Foreign Application Priority Data
Jul. 29, 2011 (CN) 201110217531.2

(51) Int. Cl. H04W 36/00; H04W 52/02

(52) U.S. Cl. CPC H04W 36/0088; H04W 52/0216
USPC 455/437

(57) ABSTRACT

In order to solve the technical problem that the discontinuous reception (DRX) decreases the accuracy and reliability of cell handover measurement, the invention proposes methods implementing a configuration of DRX and measurement in the UK and the EnodeB equipment. The method comprises, determining that a neighboring cell is discovered, the UE updates the DRX configuration, and the eNodeB equipment update the DRX configuration synchronously with the UE; the UE implements a measurement used for handover with respect to the neighboring cell based on the updated DRX configuration, and transmits a measurement report to the eNodeB equipment serving the UE, the eNodeB equipment receives the measurement report transmitted by the UE. The flexibility of measurement is improved. Preferably, the updated DRX configuration matches with the measurement opportunity, which can provide more accurate and reliable measurement results.

### TECHNICAL FILED

The invention relates to wireless communication technologies, especially relates to the DRX (discontinuous reception) technology in the communication technology of wireless HetNet.

### BACKGROUND TECHNOLOGY

In the RAN#51 meeting, the study item of “mobility improvement used for LTE HetNet” is agreed. The study item needs to consider and assure the robust mobile function (including DRX function) of each UE (user equipment) under the assumption of measurement availability, and the power consumption and complexity of the UE. One challenge in the deployment of the HetNet is the robust mobile function and to decrease the power consumption of the UE. By allowing the network to configure the UE in connected mode in discontinuous reception (DRX), the current standard solves the challenge of the power consumption of the UE. The parameterization of the DRX cycle involves a trade-off between battery saving and latency.

In the HetNet, the handover operation of the UE between a macro cell and a microcell often occurs. Firstly, the handover procedure begins when a handover target cell (neighboring cell) is discovered. Then, the UE executes a handover target cell measurement, based on a predetermined measurement requirement, and feeds back a measurement result to the eNodeB equipment of the serving cell. The eNodeB equipment of the serving cell decides whether or not to execute handover, then controls the subsequent signaling. But, for the DRX UE configured in connected mode, when it executes measurement, sparse measurement samples may occur. If the DRX on period is not matching the period of measurement, this will cause sparse measurement samples within a measurement evaluation period, resulting in less accurate and less reliable measurement data. As shown in FIG. 1, at time T0, the neighboring cell discovery ends, and the UE begins a measurement with respect to the neighboring cell. Each measuring opportunity is shown by an arrow and neighboring measuring opportunities have a measure intervals. The DRX condition of the UE is shown by a square wave, a high level shows receiving status (DRX on) and a low level shows in non-receiving status (DRX off). Obviously, at each measuring opportunity to measure, the UE may be in non-receiving status, so the measurement value can't be obtained at the measuring opportunity. Since the final measurement result is obtained by calculating the measurement values at all the measuring opportunity in the measurement cycle, the DRX may cause the measurement result inaccurate. Especially, if the time-to-trigger mechanism is adopted, the measurement report triggered after expiration will be inaccurate, which leads to the reliability of UE mobility reduced considerably. As shown in FIG. 3, when the measured quality of the neighboring cell is higher than that of the serving cell by a certain threshold, the measurement event is triggered. Later, the UE should continuously measure a given time period TTT, and trigger the report event after the time period. The UE should generate the measurement report according to the measurement result within the time period TTT. As shown in the figure, after the measurement event is triggered, the UE is in the status of DRX on and executes a measurement; but, due to the current configuration of DRX, DRX returns to off status immediately and keeps off status in the remaining time of TTT time period, therefore the UE can't continue to measure in the remaining time which causes the measurement result inaccurate.

Since there are many microcells (small cell) in the HetNet, and handover procedure occurs frequently, therefore the UE is required to execute measurement frequently. So, the above existing problem becomes especially obvious in the HetNet that the inconsistence between the ON duration time of DRX and the measurement cycle leads to inaccurate measurement.

Besides, if the UE sends the measurement result to the eNodeB equipment, it needs to receive the handover command from the eNodeB equipment. But, the UE may return to the status of DRX off before receiving the handover command from the eNodeB equipment, and then it can't receive the handover command on time, which will lead extra delay and affect handover.

Now for these technical problems, there has not been any effective solution in the industry.

### SUMMARY OF THE INVENTION

To address the above technical problems, a preferred embodiment of the invention intends to provide a technical solution to solve the problem of inaccurate measuring under DRX, and be able to provide a accurate and reliable measurement and report. The preferred embodiment of the invention also intends to solve the problem of handover command delay caused by DRX.

The invention concept of the invention is that, after discovering the neighboring cell, updating the configuration of DRX for the UE and the eNodeB equipment, and executing measurement based on the updated DRX, thus improving flexibility of measurement.

According to a basic aspect of the invention, a method is provided for implementing a configuration of DRX and measurement used for an intercell handover, in a UE, wherein, the method comprises the following steps:

i. determining that a neighboring cell is discovered;

ii. updating a DRX configuration of the UE;

iii. implementing a measurement used for handover with respect to the neighboring cell based on the updated DRX configuration, and transmitting a measurement report to an eNodeB equipment to which the UE belongs.

The merit of the aspect is improving flexibility of measurement.

According to a preferred embodiment, the step i is performed by that the UE detects the neighboring cell by itself, or the eNodeB equipment informs the UE that the neighboring cell is discovered. The embodiment provides two specific implementation methods to discover neighboring cells.

According to another preferred embodiment, the step ii is performed by that updating the DRX configuration to a default configuration. The embodiment can update DRX and execute a measurement more quickly.

Or, the step ii is performed by that receiving a latest configuration transmitted by the eNodeB equipment. The embodiment allows the eNodeB equipment determine a preferred DRX configuration and enable the eNodeB equipment to control.

Or, the step ii is performed by that updating the DRX configuration to one in a plurality of prestored configurations, wherein, determining parameters related to the DRX configuration, determining one in the plurality of prestored configurations according to the related parameters and based on a predetermined algorithm, and updating the DRX configuration to the determined configuration. The embodiment determine a preferred DRX configuration based on related parameters, e.g. the moving velocity of the UE, thus has more accurate measurement results.

According to another preferred embodiment, the updated DRX configuration is corresponding to each measurement opportunity of the measurement used for handover. The merit of the embodiment is to be able to provide more accurate measurement results.

According to another preferred embodiment, after the step i, the UE switches from a first state to a second state;

After the step iii, when a predetermined condition is met, the UE switches from the second state to the first state, the predetermined condition comprising any one of the following:
Receiving a handover command from the eNodeB equipment;
Being aware of an event of a radio link fail;
the UE leaving a coverage of the detected neighboring cell in case that not receiving the handover command or no occurring of the event of a radio link fail.

The embodiment provides a state machine which may be adopted when implementing UE.

Further preferably, after the step iii, when the predetermined condition is met, changing from the second state to the first state, and switching off the DRX newly configured. The merit is that, after switching off the DRX, the UE is always in receiving state and can receive a handover command transmitted by the eNodeB equipment in time to avoid delay.

Accordingly, based on another aspect of the invention, it is provided a method of controlling a UE to implement a configuration of DRX and measurement, in an eNodeB equipment, wherein, the method comprises the following steps:

i. determining that a neighboring cell to the UE is discovered;

ii. updating a DRX configuration synchronously with the UE;

iii. receiving a measurement report transmitted by the UE, the measurement report is obtained by the UE by implementing a measurement used for handover with respect to the neighboring cell based on the updated DRX configuration.

Other merits, aspects and features of the invention will be described below, or understood by those skilled in the art through the following elucidation.

### BRIEF DESCRIPTION OF THE DRAWINGS

The following will describe the preferred embodiments of the invention more concretely through examples referring to the following figures.

FIG. 1 illustrates the condition that the duration of DRX on state is inconsistent with the measurement cycle in the art;

FIG. 2 illustrates the condition that the duration of DRX on state is inconsistent with the measurement cycle under the time-to-trigger mechanism in current technology;

FIG. 3 illustrates a state transition diagram of a UE according to one aspect of the invention;

FIG. 4 illustrates a configuration of DRX according to one aspect of the invention;

FIG. 5 illustrates another configuration of DRX according to one aspect of the invention;

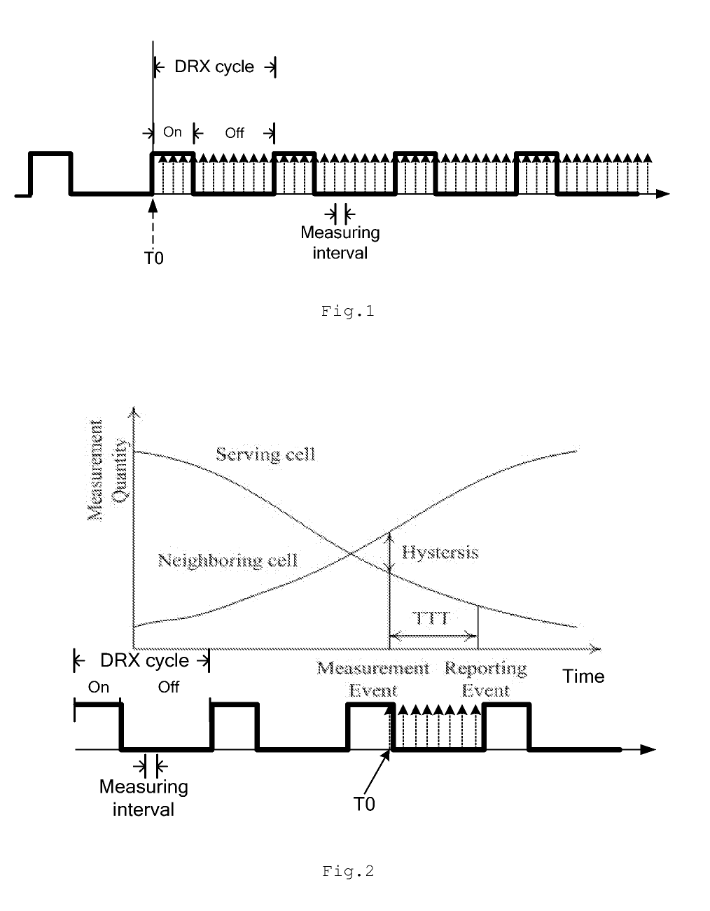

In the drawings, the same or similar reference signs represent the same or similar feature of steps or components (modules).

### DETAILED EMBODIMENT

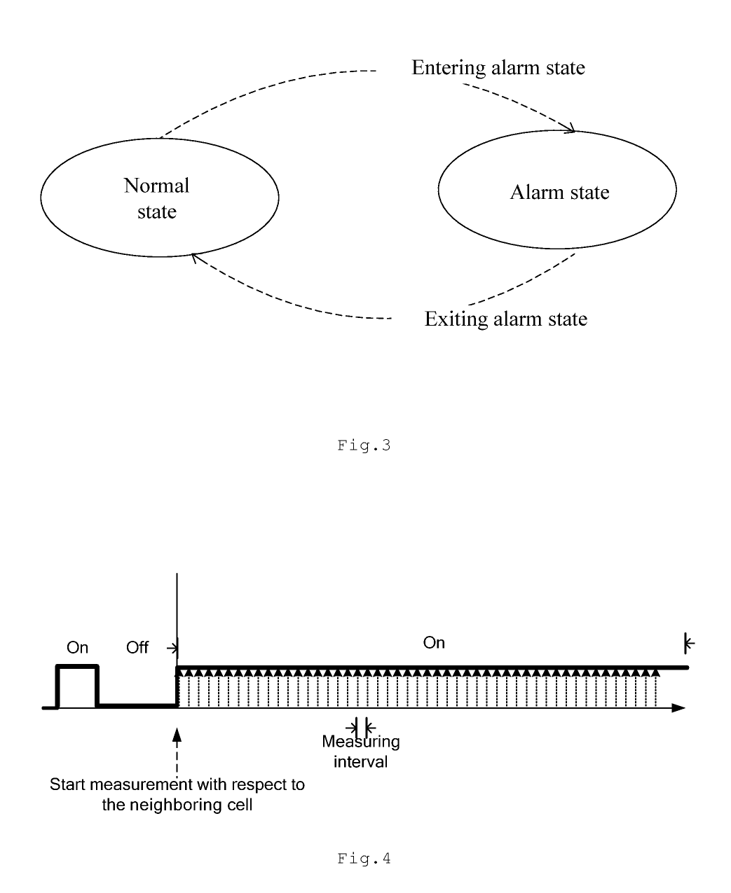

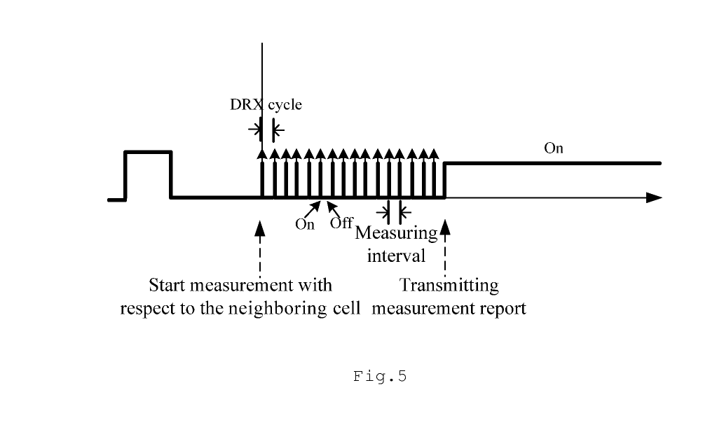

The following is detailed descriptions according to the methods and equipments of the invention, referring from FIG. 3 to FIG. 5.

The invention proposes a simple solution with low power consumption to support accurate and reliable measurements, and to support robust handover procedures. The preferred embodiment of the solution not only can solve the problem of sparse measurements caused by the DRX configuration, but also can solve the problem of handover command delay caused by the DRX. In the solution, for the UE, it comprises the following steps:

i. determining that a neighboring cell is discovered;

ii. updating a DRX configuration of the UE;

iii. implementing a measurement used for handover with respect to the neighboring cell based on the updated DRX configuration, and transmitting a measurement report to an eNodeB equipment to which the UE belongs.

Preferably, the UE may be in the first state (or called as normal state) or the second state (or called as alarm state). Wherein, the first state is used for a macro cell (or not used for a macro cell), and the second state is used for updated DRX configuration. As soon as discovering neighboring cell, the UE may enter the alarm state.

After the step iii, when a predetermined condition is met, the UE switches from the second state to the first state, the predetermined condition comprising any one of the following:
Receiving a handover (HO) command from the eNodeB equipment;
Being aware of an event of a radio link fail (RLF);
the UE leaving a coverage of the detected neighboring cell in case that not receiving the handover command or no occurring of the event of a radio link fail.

FIG. 3 shows the diagram of the UE switching between the two states.

Accordingly, for the eNodeB equipment, the method of controlling a UE to implement a configuration of DRX and measurement in the eNodeB equipment, comprises the following steps:

i. determining that a neighboring cell to the UE is discovered;

ii. updating a DRX configuration synchronously with the UE;

iii. receiving a measurement report transmitted by the UE, the measurement report is obtained by the UE by implementing a measurement used for handover with respect to the neighboring cell based on the updated DRX configuration.

Further concretely, in the above step i, the discovery of the neighboring cell may be implemented by the measuring and informing the eNodeB via the UE, or implemented by measuring and informing the UE via the eNodeB.

The above step ii may be executed in the following several modes:
The UE and eNodeB equipment respectively update the DRX configuration to a default configuration, e.g. closing the DRX;
The eNodeB equipment determining and configuring a DRX configuration, and informing the configuration to the UE by signaling;
the UE and/or the eNodeB equipment determining one in a plurality of prestored configurations, and synchronizing the UE and the eNodeB equipment with the configuration. More concretely, the UE and/or the eNodeB equipment may obtain the parameters related to the DRX, e.g. the moving velocity of the UE, via measuring, and determine one in a plurality of prestored configurations according to the parameters, then transmits the parameters or the index of the configuration to the UE and/or the eNodeB equipment via signaling, thus enable the UE and/or the eNodeB equipment to determine the configuration via the parameters or to be aware of the configuration directly.

The following will use several more specific solutions to describe the invention in detail.

Solution 1

The scheme is corresponding to that the neighboring cell is discovered by the UE, e.g. the UE maintains the cell visited once and determines the neighboring cell belongs to the microcell visited once. After the cell is discovered, the UE begins a measurement with respect to the neighboring cell, preferably enters the alarm state automatically, and updates the DRX configuration to a default configuration, e.g. keeping in on state (i.e. closing DRX). The configured DRX state and measuring opportunities are shown as FIG. 4. After finishing the measurement, the UE calculates and obtains the measurement result and transmits the measurement report to the eNodeB equipment.

Under one configuration, after receiving the measurement report, the eNodeB equipment will be aware of that the UE enters the alarm state, based on the type of the serving cell and the neighboring cell. Under another configuration, the UE informs the eNodeB equipment that the UE enters the alarm state, such as putting an alarm indication in the measurement report, and the eNodeB equipment will be synchronous with the UE and keeps in the DRX on state.

Solution 2

The solution is corresponding to that the neighboring cell is discovered by the UE. As soon as the UE searches for and discovers the neighboring cell, the UE will transmit indication information to the eNodeB equipment, indicating that it enters the alarm state, namely indicates the eNodeB equipment that the DRX configuration of the UE should be updated to meet the measurement requirement. The eNodeB equipment receives the indication information.

Later, the eNodeB equipment configures new a DRX, and transmits the updated DRX configuration to the UE, e.g. informing the UE of the on and off duration of the configured DRX. The new DRX further may relate to the moving velocity of the UE.

The UE receives the updated configuration transmitted by the eNodeB equipment, and updates the DRX configuration to the updated one.

Solution 3

The solution is corresponding to that the neighboring cell is discovered by the UE. As soon as the UE searches for and discovers the neighboring cell, the UE will transmit indication information to the eNodeB equipment, indicating that it enters the alarm state, which informs the eNodeB equipment of that the DRX configuration of the UE should be updated to meet the measurement requirement. The eNodeB equipment receives the indication information.

And, the UE prestored in advance a set of DRX configurations. The UE and the eNodeB equipment select one from the prestored set of DRX configurations for updating, according to the parameters influencing the DRX configuration.

E.g., in one case, the parameters influencing the DRX configuration, e.g. the moving velocity of the UE is obtained by the eNodeB equipment via measuring, then according to a predetermined algorithm, the eNodeB equipment selects one from the prestored set of DRX configurations to configure the DRX configuration, and transmits the index of the DRX configuration in the set of DRX configurations to the UE; or transmits the parameters influencing the DRX configuration to the UE directly, and the UE, according to the same predetermined algorithm, selects one from the prestored set of DRX configurations stored to update the DRX configuration.

In another case, the parameters influencing the DRX configuration is obtained by the UE via measuring, then according to a predetermined algorithm, the UE selects one from the prestored set of DRX configurations to configure the DRX configuration, and transmits the index of the DRX configuration in the set of DRX configurations to the eNodeB equipment; or transmits the parameters influencing the DRX configuration to the eNodeB equipment directly, and the eNodeB equipment, according to the same predetermined algorithm, selects one from the prestored set of DRX configurations to update the DRX configuration.

Besides, in another case, the UE and the eNodeB equipment can respectively measure the parameters influencing the DRX configuration. According to the same predetermined algorithm separately, they respectively select one from the prestored set of DRX configurations to update the DRX configuration, which thus saves signaling interactions between the UE and the eNodeB equipment.

Solution 4

The solution is corresponding to that the neighboring cell is discovered by the eNodeB equipment, e.g. the eNodeB equipment maintains a topological structure among itself and several neighboring cells, and determines that the UE is neighboring with some cell according to the current location of the UE. And the eNodeB equipment informs the UE of the discovery of the neighboring cell via signaling. The UE correspondingly enters the alarm state.

Then, the eNodeB equipment configures a new DRX, and transmits the updated DRX configuration to the UE. The UE updates its DRX configuration to the updated configuration, e.g., keeping in the on state (i.e. closing DRX) as shown in FIG. 4. In another example, the relationship between the configuration and the measurement cycle is shown by FIG. 6, wherein, the duration of on state is very short and coincides with the measuring opportunities for convenient measurement. Later, the UE goes back to off state for saving power, and returns to on state to measure at next coming measuring opportunity, and cycles like this. After the UE transmits the measurement report, the UE may close DRX to keep in receiving state for waiting the HO command from the eNodeB equipment, which can avoid the transmitting delay of HO command caused by the DRX.

Solution 5

The solution is corresponding to that the neighboring cell is discovered by the eNodeB equipment, and the eNodeB equipment informs the UE of the discovery of the neighboring cell via signaling. The UE correspondingly enters the alarm state.

And, the UE prestored a set of DRX configurations. The UE and the eNodeB equipment select one from the set of DRX configurations prestored for updating, according to the parameters influencing the DRX configuration.

The parameters influencing the DRX configuration, e.g. the moving velocity of the UE is obtained by the eNodeB equipment via measuring, then the eNodeB equipment selects one from the prestored set of DRX configurations to configure the DRX configuration, based on the parameters and according to a predetermined algorithm. And the eNodeB equipment transmits the index of the DRX configuration in the set of DRX configurations to the UE, the UE updates as the DRX configuration corresponding to the index; or the eNodeB equipment transmits the parameters influencing the DRX configuration to the UE directly, and the UE, according to the same predetermined algorithm, selects one from the prestored set of DRX configurations to update the DRX configuration.

Solution 6

The solution is corresponding to that the neighboring cell is discovered by the eNodeB equipment, and the eNodeB equipment informs the UE of the discovery of the neighboring cell via signaling. The UE correspondingly enters the alarm state.

And, the UE prestored a set of DRX configurations. The UE and the eNodeB equipment select one from the prestored set of DRX configurations for updating, according to the parameters influencing the DRX configuration.

The parameters influencing the DRX configuration, e.g. the moving velocity of the UE is obtained by the UE via measuring, then according to the predetermined algorithm and based on the parameters, the UE selects one from the prestored set of DRX configurations to configure the DRX configuration. And the UE transmits the index of the DRX configuration in the set of DRX configurations to the eNodeB equipment, and the eNodeB equipment configures with the DRX configuration corresponding to the index; or the UE transmits the parameters influencing the DRX configuration to the eNodeB equipment directly, and the eNodeB equipment, according to the same predetermined algorithm, selects one from the prestored set of DRX configurations to update the DRX configuration.

As a technical solution combined by the solution 5 and solution 6, the UE and the eNodeB equipment can respectively measure the parameters influencing the DRX configuration, and according to the same predetermined algorithm, they respectively select one from the prestored set of DRX configurations to update the DRX configuration, which thus saves signaling interactions between the UE and the eNodeB equipment.

Though the drawings and above description explain and describe the invention in detail, the explanation and description should be construed to be explanatory and illustrative, instead of limiting. The invention is not limited to the above embodiments.

Those skilled in the art can understand and implement other modifications of the disclosed embodiments, by studying the specification, disclosure, drawings and appended claims. In the actual application of the invention, a component may implement functions of multiple technical features cited in claims. In the claims, the word “comprises” doesn't exclude other components and steps, and the word “a” doesn't exclude plurality. Any reference signs in the claims should not be construed as a limit to the scope.

1. A method for implementing a configuration of DRX and measurement used for an intercell handover, in a UE, wherein the method comprises:
determining that a neighboring cell is discovered;
Updating a DRX configuration of the UE; and
implementing a measurement used for handover with respect to the neighboring cell based on the updated DRX configuration, and transmitting a measurement report to an eNodeB equipment to which the UE belongs.

2. A method of claim 1, wherein the determining is performed by that the UE detects the neighboring cell by itself; and
updating a DRX configuration of the UE comprises any of the following items:
updating the DRX configuration to a default configuration;
transmitting an indication to the eNodeB equipment which updates a new configuration and transmits the updated configuration to the UE, receiving the updated configuration transmitted by the eNodeB equipment, and updating the DRX configuration to the updated configuration; and
updating the DRX configuration to one in a plurality of prestored configurations.

3. A method of claim 1, wherein determining that a neighboring cell is discovered is performed by the eNodeB equipment that informs the UE that the neighboring cell is discovered;
updating a DRX configuration of the UE comprises:
receiving a latest configuration transmitted by the eNodeB equipment, and updating the DRX configuration to the latest configuration;
updating the DRX configuration to one in a plurality of prestored configurations.

4. A method of claim 2, wherein updating the DRX configuration to one in a plurality of prestored configurations comprises any of the following items:
receiving an index, transmitted by the eNodeB equipment, of one in the plurality of prestored configurations, and updating the DRX configuration to a configuration corresponding to the index;
determining parameters related to the DRX configuration, determining one in the plurality of prestored configurations according to the related parameters and based on a predetermined algorithm, and updating the DRX configuration to the determined configuration.

5. A method of claim 4, wherein the parameters related to the DRX configuration comprise:
a moving velocity of the UE;
the operation of determining the parameters related to the DRX configuration comprises any of the following:
receiving the parameters transmitted by the eNodeB equipment;
measuring the parameters by the UE itself.

6. A method of claim 5, wherein when the UE measures the parameters by itself, the method further comprises:
transmitting the parameters or an index of the determined one in the plurality of prestored configurations to the eNodeB equipment, for the eNodeB equipment to synchronize the DRX configuration.

7. A method of claim 1, wherein the updated DRX configuration is corresponding to each measurement opportunity of the measurement used for handover;
after determining that a neighboring cell is discovered, the UE switches from a first state to a second state;
after implementing a measurement used for handover with respect to the neighboring cell based on the updated DRX configuration, and transmitting a measurement report to an eNodeB equipment to which the UE belongs, when a predetermined condition is met, the UE switches from the second state to the first state, the predetermined condition comprising any one of the following:
receiving a handover command from the eNodeB equipment;
being aware of an event of a radio link fail;
the UE leaving a coverage of the detected neighboring cell in case of not receiving the handover command or no occurring of the event of a radio link fail.

8. A method of claim 7, wherein after implementing a measurement used for handover with respect to the neighboring cell based on the updated DRX configuration, and transmitting a measurement report to an eNodeB equipment to which the UE belongs, when the predetermined condition is met, changing from the second state to the first state, and switching off the DRX newly configured.

9. A method of controlling a UE to implement a configuration of DRX and measurement, in an eNodeB equipment, wherein the method comprises:
determining that a neighboring cell to the UE is discovered;
updating a DRX configuration synchronously with the UE;
receiving a measurement report transmitted by the UE, the measurement report being obtained by the UE by implementing a measurement used for handover with respect to the neighboring cell based on the updated DRX configuration.

10. A method of claim 9, wherein determining that a neighboring cell to the UE is discovered is performed by that the UE informs that the neighboring cell is discovered, and updating a DRX configuration synchronously with the UE adopts a default configuration to synchronize with the UE; or:
determining that a neighboring cell to the UE is discovered is performed by that the UE informs that the neighboring cell is discovered; and
updating a DRX configuration synchronously with the UE comprises any of the following:
configuring a new DRX, and transmitting the updated configuration to the UE; or
adopting one in a plurality of prestored configurations, the one in plurality of prestored configurations is determined by the UE and/or the eNodeB equipment, and synchronizing the UE and the eNodeB equipment.

11. A method of claim 9, wherein determining that a neighboring cell to the UE is discovered is performed by that the eNodeB equipment detects the neighboring cell by itself; and
updating a DRX configuration synchronously with the UE comprises any of the following:
configuring a new DRX, and transmitting the updated configuration to the UE;
determining one in a plurality of prestored configurations by the UE and/or the eNodeB equipment, and synchronizing the UE and the eNodeB equipment.

12. A method of claim 10, wherein determining one in a plurality of prestored configurations by the UE and/or the eNodeB equipment, and synchronizing the UE and the eNodeB equipment comprises any of the following:
receiving an index, transmitted by the UE, of one in the plurality of prestored configurations, and synchronizing with a configuration corresponding to the index;
determining parameters related to the DRX configuration, and determining one in the plurality prestored configurations according to the related parameters and based on a predetermined algorithm, the parameters being determined by the eNodeB equipment and/or the UE.

13. A method of claim 12, wherein the parameters related to the DRX configuration comprise:
a moving velocity of the UE;
the operation of determining the parameters related to the DRX configuration comprises any of the following items:
measuring the parameters by the eNodeB equipment itself;
receiving the parameters transmitted by the UE.

14. A method of claim 13, wherein determining parameters related to the DRX configuration, and determining one in the plurality prestored configurations according to the related parameters and based on a predetermined algorithm, the parameters being determined by the eNodeB equipment and/or the UE comprises any of the following:
transmitting the parameters to the UE in case that the eNodeB equipment measures the parameters by itself;
transmitting the index of the one in the plurality of prestored configurations to the UE.
